(19) United States
(12) Patent Application Publication
(10) Pub. No.: US 2015/0308575 A1
(43) Pub. Date: Oct. 29, 2015

(54) Sealing Ring and Pressure Transducer having at least one such Sealing Ring

(71) Applicant: ENDRESS + HAUSER GMBH + CO. KG, Maulburg (DE)

(72) Inventor: Michael Hugel, Lorrach (DE)

(21) Appl. No.: 14/381,296

(22) PCT Filed: Feb. 7, 2013
(86) PCT No.: PCT/EP2013/052386

§ 371 Date: Aug. 27, 2014

(30) Foreign Application Priority Data
Mar. 8, 2012 (DE) 10 2012 004 406.2
Mar. 28, 2012 (DE) 10 2012 102 676.9
Apr. 2, 2012 (DE) 10 2012 102 834.6

(51) Int. Cl. F16J 15/08; G01L 7/08; F16J 15/10

(52) U.S. Cl. CPC F16J 15/0887; F16J 15/0806; F16J 15/104; F16J 15/102; G01L 7/08

(57) ABSTRACT

A sealing ring for sealing in the axially clamped state includes a metal or ceramic annular body, which has in cross section a first spring leg having at least a first sealing surface on a first end of the annular body and a second spring leg having at least a second sealing surface on a second end of the annular body, which faces away from the first end. Between the first spring leg and the second spring leg a diagonal connecting leg extends, which is connected with the first spring leg in an inner edge region of the annular body and with the second spring leg in an outer edge region of the annular body. The first sealing surface has a plastic sealing material, and the second sealing surface has a plastic sealing material. The sealing ring has especially on at least one end two sealing surfaces, which are radially spaced from one another and isolated from one another by an annular axial recess in the spring leg.

The present invention relates to a sealing ring and to a pressure transducer having at least one such sealing ring.

In the process industry, media are processed, which established elastomers only conditionally withstand. It is, consequently, usual, in the case of media-contacting seals, not to use the otherwise usual elastomers, in case aggressive media are to be expected. Instead, metal seals or inert synthetic materials, especially fluoropolymers, such as, for example, PTFE, FEP or PFA are applied. Design of the components to be sealed relative to one another must then adapt to the special properties of the seal materials. Thus, for example, metal seals require, as a general rule, large clamping forces, in order to apply the required surface pressure and fluoropolymers seals must be elastically prestressed, in order to be able to accommodate thermal expansion differences between the, usually, metal sealing partners and the seal, thermal warping in the construction, loosening screws and, in given cases, hysteresis phenomena associated with the aforementioned effects as well as creep of the sealing material and manufacturing tolerances.

These considerations present a problem for industrial process measurements technology, since the measuring devices should be suitable with an as small as possible number of variations as regards design for the most varied of process media. Since, most often, elastomeric seals suffice, it is not justified to provide all devices with such a complex construction that they can sufficiently elastically prestress thermoplastic seals.

It is, consequently, an object of the present invention to provide a sealing ring and a pressure measuring transducer with such a sealing ring, wherein the sealing ring is applicable in place of an elastomeric seal and has chemically resistant materials.

The object is achieved by the sealing ring as defined in independent patent claim 1 and the pressure measuring transducer as defined in independent patent claim 11.

The sealing ring of the invention for sealing in the axially clamped state comprises a metal or ceramic annular body, which has in cross section a first spring leg having at least a first sealing surface on a first end of the annular body and a second spring leg having at least a second sealing surface on a second end of the annular body, which faces away from the first end, wherein between the first spring leg and the second spring leg a diagonal connecting leg extends, which is connected with the first spring leg in an inner edge region of the annular body and with the second spring leg in an outer edge region of the annular body, wherein the first sealing surface has a plastic sealing material, and wherein the second sealing surface has a plastic sealing material.

In a further development of the invention, the sealing ring has on at least one end two sealing surfaces, which are radially spaced from one another and are isolated from one another by an annular axial recess in the spring leg, wherein, in a currently preferred further development of the invention, the two end faces each have two sealing surfaces, which are radially spaced from one another and are isolated from one another by an annular axial recess in the spring leg.

In a further development of the invention, in each case, an inner of the two sealing surfaces extends up to an inner edge region of the respective end of the sealing ring and an outer of the two sealing surfaces extends up to an outer edge region of the respective end face.

The axial recess in a spring leg effects that the spring leg between the sealing surfaces is softer so that the spring leg is there easier deformable without degrading the integrity of the sealing surfaces. The axial depressions, thus, unload transition regions between the spring legs and the connecting leg, whereby the amount of plastic deformation in this transitional region in the case of a given axial compression of the sealing ring compared with sealing rings without such an axial recess in the spring legs is significantly reduced.

In a further development of the invention, at least one axial recess, preferably the two axial recesses, has/have in the relaxed equilibrium state of the annular body in cross section a minimal surrounding rectangle, whose area amounts to at least 1%, preferably at least 1.5% and further preferably at least 1.8% of the area of the rectangle minimally surrounding the cross section of the annular body.

In the cross section of the annular body, the connecting leg is bordered by radial recesses relative to an axial external line at the outer radius of the annular body and an axial internal line at the inner radius of the annular body.

In a further development of the invention, at least one minimal triangle surrounding one of the radial recesses has an area, which amounts to not less than 10%, preferably not less than 14% and especially preferably not less than 16% of the area of the rectangle minimally surrounding the cross section of the annular body.

In a further development of the invention, at least one axial recess, preferably the two axial recesses, has in the relaxed equilibrium state of the annular body in cross section a minimal surrounding rectangle, whose area amounts to between 8% and 16%, especially between 10% and 14%, of the area of the minimum triangle surrounding the respectively adjoining radial recess.

The adjoining radial recess of an axial recess is that radial recess, which borders the spring leg, in which the axial recess is formed.

The sealing ring is especially so embodied that it has, after an axial compression dz due to an axial clamping, wherein dz amounts to not less than 2% of the maximal axial distance between the two end faces of the annular body, especially not less than 3% of the maximal axial distance between the two end faces, and preferably not less than 4% of the maximal axial distance between the two end faces, after elimination of the axial clamping, a relaxation of at least 0.2 dz, preferably at least 0.3 dz.

In a further development of the invention, the end faces of the annular body have in cross section rounded edge regions, whose radius of curvature amounts to not less than 0.2 mm, preferably not less than 0.4 mm.

The minimal rectangle enveloping the cross section in the equilibrium state of the annular body has according to a further development of the invention a height, which amounts to not more than 90%, preferably not more than 80% and further preferably not more than 75% of its width, wherein the height is given by the maximal axial equilibrium distance between the end faces of the annular body and the width corresponds to the difference between the outer radius and the inner radius of the annular body.

In a further development, the plastic sealing material comprises a fluorine polymer, especially PTFE, FEP or PFA, preferably in an average thickness of not less than 20 μm and not more than 100 μm.

In a currently preferred embodiment, the average thickness amounts to not less than, for instance, 30 μm, and not more than, for instance, 50 μm, especially, for instance, 35 μm to 45 μm.

The PTFE can especially—after appropriate cleaning and, in given cases, plasma treatment of the surfaces of the annular body, be applied as a suspension and solidified by means of sintering.

In another further development of the invention, the plastic sealing material comprises a ductile metal, for example, silver, copper or gold.

In a further development of the invention, the annular body comprises stainless steel, Hastelloy or another elastic metal material.

In another further development of the invention, the annular body comprises an elastic, ceramic material, especially zirconium oxide.

The pressure measuring transducer of the invention comprises a hydraulic measuring mechanism, which has a measuring mechanism body and at least a first isolating diaphragm, which is connected along a peripheral joint with the measuring mechanism body and contactable with a medium, wherein the isolating diaphragm has in its edge region an annular isolating diaphragm sealing surface; wherein the pressure measuring transducer furthermore has at least one process connection body, wherein the process connection body has a pressure output opening, by which the isolating diaphragm is contactable with the medium, wherein the pressure output opening is annularly surrounded by a first process connection sealing surface; wherein the pressure measuring transducer furthermore has at least one sealing ring of the invention, wherein the sealing ring is axially clamped between the first isolating diaphragm sealing surface and the first process connection sealing surface.

In a further development of the invention, there is embodied between the measuring mechanism body and the process connection body an axial stop, especially a rigid axial stop, which especially surrounds the ring-shaped sealing ring, so that the sealing ring with the help of the axial stop is clamped with a defined axial compression.

The pressure measuring transducer of the invention includes, according to a further development of the invention, a measuring transducer, which is arranged in a transducer chamber in the measuring mechanism body and contactable via a hydraulic path with the pressure acting on the isolating diaphragm.

In a further development of the invention, the sealing ring has due to the axial clamping an axial compression dz, which amounts to not less than 2%, especially not less than 3% and preferably not less than 4% of the maximal axial distance between the two end faces, wherein the axial compression dz amounts to not more than 10%, especially not more than 8% and preferably not less than 7% of the maximal axial distance between the two end faces.

In a further development of the invention, the sealing ring is axially clamped in such a manner that the plastic sealing material over a temperature range of −20° C. to 70° C., especially of −40° C. to 80° C., is subject to an areal pressure varying with the radius and covering at least the range of 0.4 MPa to 40 MPa.

In a further development of the invention, the sealing ring is axially clamped with such an areal pressure that the plastic sealing material is penetrated by the metal or ceramic annular body in at least one radial region, so that the metal or ceramic annular body in this radial region lies directly on the isolating diaphragm sealing surface.

In a further development of the invention, the pressure measuring transducer is a pressure difference transducer for registering the difference between a first media pressure and a second media pressure, wherein the pressure difference transducer has besides the first isolating diaphragm a second isolating diaphragm, which is contactable with a medium and has a second annular isolating diaphragm sealing surface; wherein the pressure difference transducer has furthermore a second process connection body, a second pressure output opening, through which the second isolating diaphragm is contactable with a medium, wherein the second pressure output surface is annularly surrounded by a second process connection sealing surface; wherein the pressure difference transducer has furthermore a second sealing ring of the invention, wherein the second sealing ring is axially clamped between the second isolating diaphragm sealing surface and the second process connection sealing surface, wherein the pressure difference transducer has a pressure difference measuring transducer, which is furthermore contactable with the media pressures acting on the two isolating diaphragms, in order to ascertain their difference.

In a further development of the invention, the measuring mechanism body is axially clamped between the first process connection body and the second process connection body.

The invention will now be explained based on the example of an embodiment illustrated in the drawing, the figures of which show as follows:

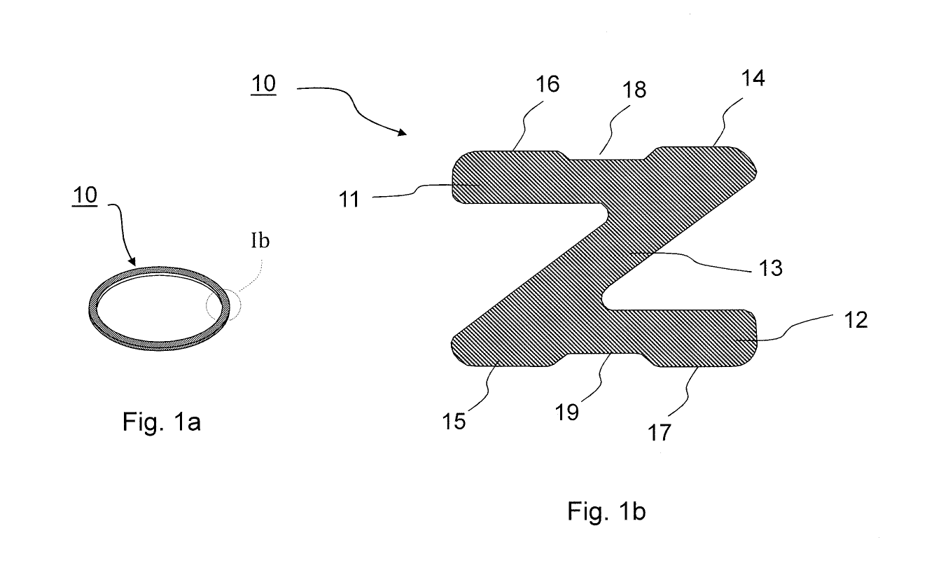

FIG. 1a a perspective view of an example of an embodiment of a sealing ring of the invention;

FIG. 1b a cross section through the sealing ring of FIG. 1a at the position 1b of FIG. 1a;

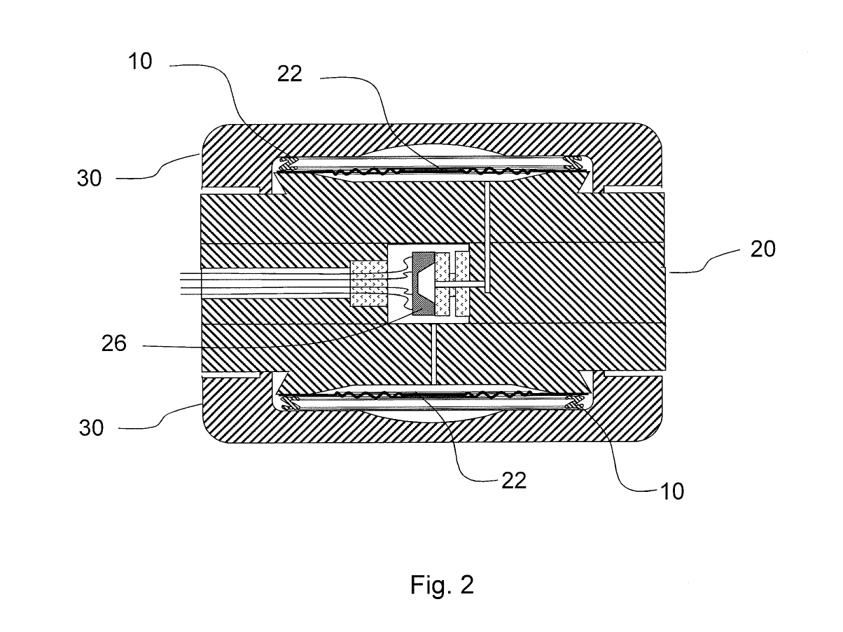

FIG. 2 a schematic longitudinal section through an example of an embodiment of a pressure difference measuring transducer of the invention;

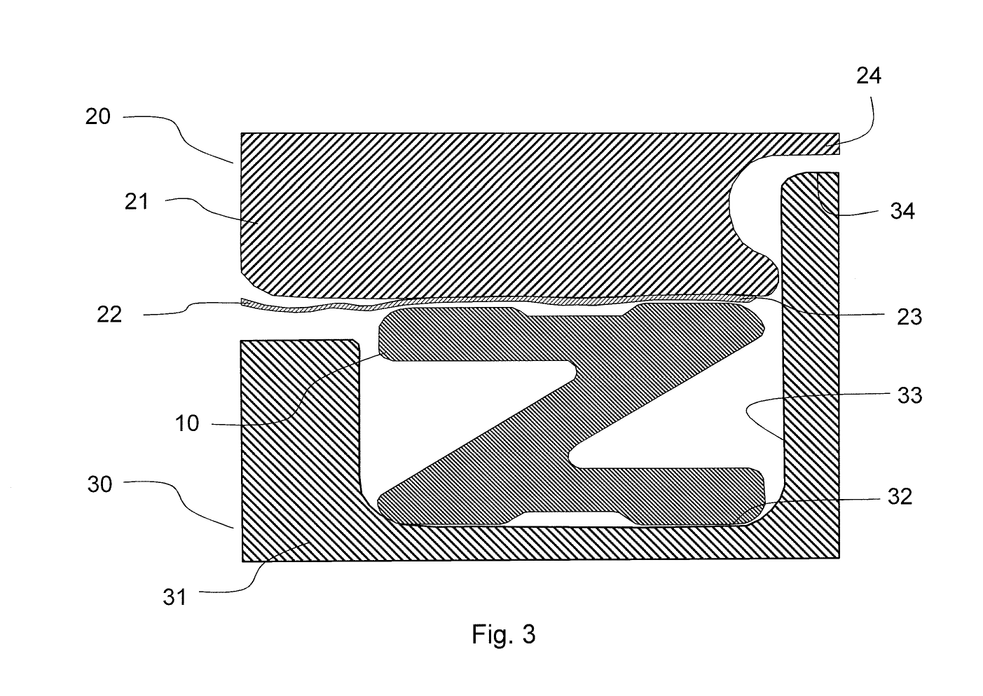

FIG. 3 a detail cross section of an example of an embodiment of a pressure difference measuring transducer of the invention; with the sealing ring in the relaxed state

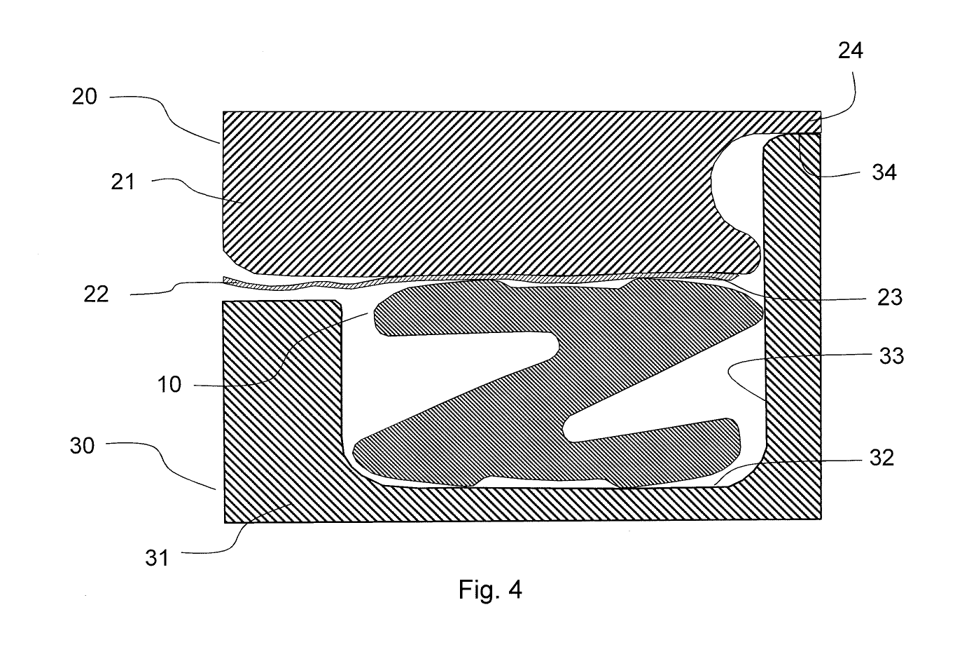

FIG. 4 a detail cross section of an example of an embodiment of a pressure difference measuring transducer of the invention; with the sealing ring in the clamped state; and

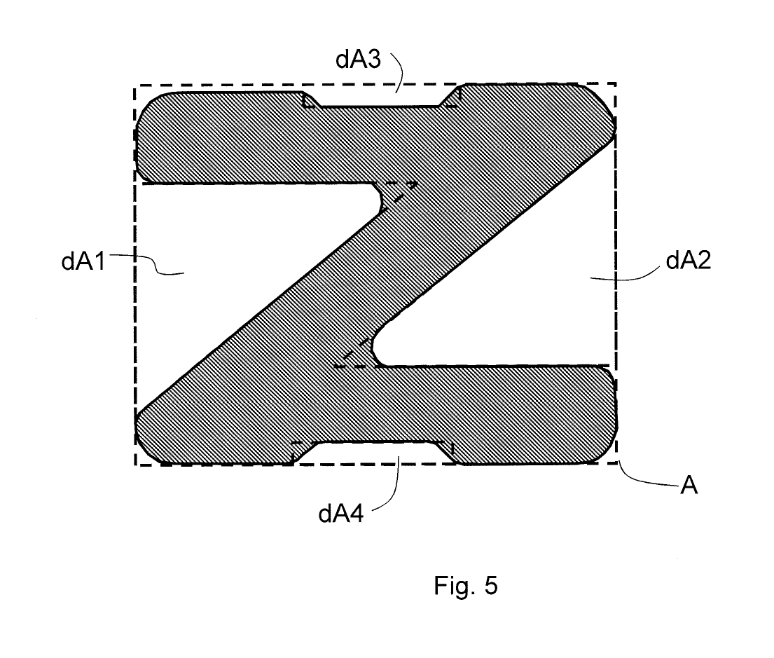

FIG. 5 a sketch for explaining some definitions.

The example of an embodiment of a sealing ring of the invention 10 shown in FIGS. 1a and 1b comprises corrosion resistant, stainless steel. The sealing ring has an outer diameter of, for instance, almost 5 cm. The inner diameter is, for instance, 0.7 cm smaller. The height of the sealing ring, 10, thus the maximum separation in the axial direction, amounts, for instance, to a fourth of a cm.

Sealing ring 10 has essentially the cross sectional shape shown in FIG. 1b, which is characterized by two essentially, for instance, parallel, spring legs 11, 12 and a diagonally extending connecting leg 13 connecting these. This shape will be referenced herein also as a Z-shape.

The spring legs (11, 12) have on the two end faces of the sealing ring, in each case, two sealing surfaces 14, 16, 15, 17, which are radially spaced and isolated from one another by axial recesses 18, 19. The recesses can be, for example, a number of 10ths of a mm, in each case, measured by the height of the sealing surface farthest above. As indicated in FIG. 1b, the heights of the sealing surfaces 15, 17 on the lower spring leg 12 and the height of the sealing surface 16 on the free end of the upper spring leg are somewhat smaller than the height of the sealing surface 14 on the end of the spring leg 12 connected with the connecting leg 13. As a result, the areal pressure achieved with the sealing surface 16 at the free end of the spring leg against a planar, opposing surface is somewhat reduced. In a preferred embodiment, this sealing surface 16 should seal against an isolating diaphragm. The reduced areal pressure reduces the disturbing influence of the sealing ring on the transfer behavior of the isolating diaphragm.

Of course, the sealing surfaces 14, 15, 16, 17 and the axial recesses 18, 19 are ring-shaped, or annular.

The axial recesses serve especially, on the one hand, to soften the spring leg and, on the other hand, to produce surface pressure gradients for a plastic sealing material, wherein the plastic sealing material comprises especially a PTFE layer with a thickness of, for instance, 40 μm. The coating with PTFE can occur, for example, by applying a suspension with following sintering at temperatures up to 300° C. A commercial purveyor of such coatings is, for example, the firm, Rhenoterm, of Kempen, Germany.

For describing the size of the axial recesses, short reference is made to FIG. 5. FIG. 5 shows a rectangle jacketing the cross section of the annular body and having an area A. This rectangle is the smallest possible rectangle, which can envelop the cross section. Similar enveloping rectangles with minimal areas dA3, dA4 define the axial recesses between the sealing surfaces. The enveloping rectangles for the axial recesses extend inwards from the edge of the rectangle enveloping the annular body and surround their recesses completely.

In the case in which the sealing surfaces adjoining the recess have unequal heights, such as is the case for the recess with the area dA3, the recess enveloping rectangle extends radially to the radius, at which the height of the adjoining sealing surface is reached, respectively after a sequence of a strong concave and a following strong convex curvature at the edge of the recess practically no more curvature is present, or only a so weak curvature occurs that the radius of curvature is greater than the axial height of the sealing ring.

With these definitions, the areas dA3, dA4 of the enveloping rectangles of the axial recesses 18, 19 amount, for instance, to a 50th of the area A of the enveloping rectangle.

With corresponding definitions for enveloping triangles with areas dA1, dA2, which surround radial recesses, which border the connecting leg, and which are likewise presented in FIG. 5, the radial recesses bounding the connecting leg can be described by minimal enveloping triangles, whose areas dA1, dA2 have, for instance, in each case, a sixth to, for instance, a fifth of the area A of the rectangle enveloping the annular body.

In other words, the areas of the enveloping rectangles of the axial recesses amount, in each case, to more than 10% of the area of the just discussed triangles. Therewith, the axial recesses contribute significantly to the flexibility of the annular body, whereby the respective transition regions between the cantilevers 11, 12 and the connecting strut 13 are relaxed.

Based on FIGS. 2 to 4, the action of the sealing ring 10 in the case of a pressure difference measuring transducer 20 of the invention will now be explained. FIG. 2 shows a pressure difference transducer of the invention having a hydraulic measuring mechanism body, which is axially clamped between two process connectors 30, so-called process connector flanges, and, in each case, an interposed sealing ring 10, in order to be able to supply via two frontal, isolating diaphragms 22, in each case, a media pressure, supplied through the process connector flanges 30, to a pressure difference measuring transducer element 26 in a transducer chamber in the interior of the measuring mechanism body.

The action of the clamped sealing rings 10 will now be explained more exactly based on FIGS. 3 and 4. FIG. 3 shows, first of all, a sealing ring 10, which is loose and free of stress and sitting in a peripheral annular groove 33 in an edge region 31 of a process connection body. Superimposed from above is a hydraulic measuring mechanism body 21, wherein directly facing the upper side of the sealing ring is positioned an edge region of an isolating diaphragm 22, which serves as an isolating diaphragm sealing surface 23. First, the sealing surfaces of the sealing ring 10, a base of the annular groove 32 serving as sealing surface and the isolating diaphragm sealing surface 23 extend essentially parallel to one another, especially planparallel.

By clamping the sealing ring 10 with an axial compression amounting to a good 4% of its axial height, the sealing ring is significantly deformed, such as shown in FIG. 4, wherein both the connecting leg as well as also the spring legs have deformations. The extent of the clamping is defined by an axial stop 24, 34 between the process connection body 30 and the measuring mechanism body 21.

The shown deformation of the spring legs leads, in each case, in the edge regions of the sealing surfaces, which face the axial recesses, to surface pressure maxima, such that the PTFE-layer is penetrated. In each case, the areal pressure steadily decreases toward the inner and outer edges of the annular body, so that always a surface pressure range between 40 MPa and 0.4 MPa is reliably covered.

The remaining elasticity in the annular body is sufficient to accommodate stress changes between the process connection body and the measuring mechanism body.

1-16. (canceled)

17. A sealing ring for sealing in the axially clamped state, comprising:
a metal or ceramic annular body, which has in cross section a first spring leg having at least a first sealing surface on a first end of the annular body and a second spring leg having at least a second sealing surface on a second end of the annular body, which faces away from the first end, wherein:
between said first spring leg and said second spring leg a diagonal connecting leg extends, which is connected with said first spring leg in an inner edge region of said annular body and with said second spring leg in an outer edge region of said annular body; and
said first sealing surface has a plastic sealing material, and said second sealing surface has a plastic sealing material.

18. The sealing ring as claimed in claim 17, wherein:
the sealing ring has on at least one end two sealing surfaces, which are radially spaced from one another and are isolated from one another by an annular axial recess in the spring leg.

19. The sealing ring as claimed in claim 18, wherein:
there are two end faces, each having two sealing surfaces, which are radially spaced from one another and are isolated from one another by said annular axial recess in said spring leg.

20. The sealing ring as claimed in claim 18, wherein:
at least one axial recess has in the relaxed equilibrium state of said annular body in cross section a minimal surrounding rectangle, whose area amounts to at least 1% preferably at least 1.5% and further preferably at least 1.8% of the area of the rectangle minimally surrounding the cross section of said annular body.

21. The sealing ring as claimed in claim 17, wherein:
in the cross section of said annular body, said connecting leg is bordered by radial recesses relative to an axial external line at the outer radius of said annular body and an axial internal line at the inner radius of said annular body; and
at least one minimal triangle surrounding one of the radial recesses has an area, which amounts to not less than 10%, preferably not less than 14% and especially preferably not less than 16% of the area of the rectangle minimally surrounding the cross section of said annular body.

22. The sealing ring as claimed in claim 18, wherein:
at least one axial recess, preferably the two axial recesses, has/have in the relaxed equilibrium state of said annular body in cross section a minimal surrounding rectangle, whose area amounts to between 8% and 16%, especially between 10% and 14%, of the area of the minimum triangle surrounding, in each case, the adjoining radial recess.

23. The sealing ring as claimed in claim 17, wherein:
the sealing ring has after an axial compression due to an axial clamping; and
said compression amounts to not less than 2%, especially not less than 3%, and preferably not less than 4% of the maximal axial distance between said two end faces, after elimination of the axial clamping, a relaxation of at least 0.2 dz, preferably at least 0.3 dz.

24. The sealing ring as claimed in claim 17, wherein:
said end faces of said annular body have in cross section rounded edge regions, whose radius of curvature amounts to not less than 0.2 mm, preferably not less than 0.4 mm.

25. The sealing ring as claimed in claim 17, wherein:
the minimal rectangle enveloping the cross section in the equilibrium state of said annular body has a height, which amounts to not more than 90%, preferably not more than 80% and further preferably not more than 75% of its width; and
the height is given by the maximal axial equilibrium distance between said end faces of said annular body and the width corresponds to the difference between the outer radius and the inner radius of said annular body.

26. The sealing ring as claimed in claim 17, wherein:
the plastic sealing material comprises a fluorine-polymer, especially PTFE, FEP or PFA, preferably in an average thickness of not less than 20 μm and not more than 100 μm; and
the average thickness amounts to not less than, for instance, 30 μm and not more than, for instance, 50 μm, especially, for instance, 35 μm to 45 μm.

27. A pressure measuring transducer, comprising:
a hydraulic measuring mechanism, which has a measuring mechanism body and at least a first isolating diaphragm, which is connected with said measuring mechanism body along a peripheral joint and contactable with a medium; and at least one process connection body, wherein:
said isolating diaphragm has in its edge region an annular isolating diaphragm sealing surface;
said process connection body has a pressure output opening, by which said isolating diaphragm is contactable with the medium;
said pressure output opening is annularly surrounded by a first process connection sealing surface;
pressure measuring transducer furthermore has at least one sealing ring for sealing in the axially clamped state, comprising: a metal or ceramic annular body, which has in cross section a first spring leg having at least a first sealing surface on a first end of the annular body and a second spring leg having at least a second sealing surface on a second end of the annular body, which faces away from the first end, wherein: between said first spring leg and said second spring leg a diagonal connecting leg extends, which is connected with said first spring leg in an inner edge region of said annular body and with said second spring leg in an outer edge region of said annular body; and said first sealing surface has a plastic sealing material, and said second sealing surface has a plastic sealing material; and
said sealing ring is axially clamped between said first isolating diaphragm sealing surface and said first process connection sealing surface.

28. The pressure measuring transducer as claimed in claim 27, wherein:
there is embodied between said measuring mechanism body and said process connection body an axial stop, especially a rigid axial stop, so that said sealing ring with the help of said axial stop is clamped with a defined axial compression.

29. The pressure measuring transducer as claimed in claim 27, wherein:
said sealing ring has due to the axial clamping an axial compression, which amounts to not less than 2%, especially not less than 3% and preferably not less than 4% of the maximal axial distance between the two end faces; and
said axial compression amounts to not more than 10%, especially not more than 8% and preferably not less than 7% of the maximal axial distance between said two end faces.

30. The pressure measuring transducer as claimed in claim 27, wherein:
said sealing ring is axially clamped in such a manner that the plastic sealing material over a temperature range of −20° C. to 70° C., especially from −40° C. to 80° C. is subject to an areal pressure varying with the radius and covering at least the range of 0.4 MPa to 40 MPa.

31. The pressure measuring transducer as claimed in claim 27, wherein:
said sealing ring is axially clamped with such an areal pressure, that the plastic sealing material is penetrated by said metal or ceramic annular body in at least one radial region, so that said metal or ceramic annular body in this radial region lies directly on said isolating diaphragm sealing surface.

32. The pressure measuring transducer as claimed in claim 27, wherein:
the pressure measuring transducer is a pressure difference transducer for registering the difference between a first media pressure and a second media pressure;
the pressure measuring transducer has furthermore a second isolating diaphragm, which is contactable with a medium, and a second annular isolating diaphragm sealing surface;
the pressure difference transducer has furthermore a second process connection body and a second pressure output opening, through which the second isolating diaphragm is contactable with a medium;
said second pressure output surface is annularly surrounded by a second process connection sealing surface;
the pressure difference transducer has furthermore a second sealing ring, comprising: a metal or ceramic annular body, which has in cross section a first spring leg having at least a first sealing surface on a first end of the annular body and a second spring leg having at least a second sealing surface on a second end of the annular body, which faces away from the first end, wherein: between said first spring leg and said second spring leg a diagonal connecting leg extends, which is connected with said first spring leg in an inner edge region of said annular body and with said second spring leg in an outer edge region of said annular body; and said first sealing surface has a plastic sealing material, and said second sealing surface has a plastic sealing material;
said second sealing ring is axially clamped between said second isolating diaphragm sealing surface and said second process connection sealing surface; and
the pressure difference transducer has a pressure difference measuring transducer, which is, furthermore contactable with the media pressures acting on the two isolating diaphragms, in order to ascertain their difference.
